(19) United States
(12) Patent Application Publication
(10) Pub. No.: US 2016/0241161 A1
(43) Pub. Date: Aug. 18, 2016

(54) CONVERTING CIRCUIT

(71) Applicant: Semikron Elektronik GmbH & Co., KG, Nurnberg (DE)

(72) Inventors: Kevork HADDAD, Hollis, NH (US); Andreas GIESSMANN, Nurnberg (DE)

(21) Appl. No.: 14/695,006

(22) Filed: Apr. 23, 2015

Related U.S. Application Data
(60) Provisional application No. 62/115,242, filed on Feb. 12, 2015.

(51) Int. Cl. H02M 7/537

(52) U.S. Cl. CPC H02M 7/537

(57) ABSTRACT

A current converter circuit arrangement, and a current converter device embodying such arrangement, having positive and negative potential voltage connections, a neutral connection, an AC voltage connection, and first and second inductances. The arrangement further has at least six power semiconductor switches, to each of which a diode is electrically connected back-to-back in parallel, and two further diodes, for a total of eight. The inventive current converter circuit arrangement requires only a low number of power semiconductor switches, at a minimum six, to generate at least five voltage levels at the AC voltage connection.

### BACKGROUND OF THE INVENTION

1. Field of the Invention

The invention is directed to a current converter circuit arrangement.

2. Description of the Related Art

There are many kinds of current converters, including two-level current converters and multi-level current converters. A multi-level current converter differs from commonly known two-level current converters in that a multi-level current converter, when operated as an inverter, can generate between its AC voltage-side connections not only electric voltage levels the voltage values of which correspond to the electric positive or negative electric voltage of an intermediate circuit voltage Ud or 0 V, like a two-level current converter, but can generate further voltage levels between its AC voltage-side connections.

As a result of this, it is possible for the AC voltages generated by the current converter at its AC voltage-side connections to better approximate a sinusoidal AC voltage.

In this case, a multi-level current converter has a plurality of current converter circuit arrangements which are electrically interconnected with one another to form a multi-level current converter.

FIG. 1 illustrates a current converter circuit arrangement 1′ which is conventional in the art. In each case, half the intermediate circuit voltage Udc/2 is present between positive potential connection DC+′ and neutral connection N′ and between neutral connection N′ and negative potential connection DC−′ of the current converter circuit arrangement 1′. For this purpose, the current converter circuit arrangement 1′ is fed from two voltage sources—not illustrated in FIG. 1—which each generate half the intermediate circuit voltage Ud/2. The current converter circuit arrangement 1′ generates at its AC voltage connection AC′ with appropriate switching of its six power semiconductor switches T1 to T6 an electric voltage U having neutral connection N′ of the current converter circuit arrangement as its reference, the voltage values of which electric voltage may assume half the positive intermediate circuit voltage Udc/2, half the negative intermediate circuit voltage −Udc/2 or 0 V. Thus, AC voltage connection AC′ can assume the three voltage levels, namely Udc/2, 0 V and −Udc/2, with reference to neutral connection N′, that is to say the voltage U.

It should be noted here that, for reasons of clarity, neutral connection N′ or N which the electric voltage U has as reference is shown as a separate detail in FIGS. 1, 2, 3 and 5.

The following switching-state table illustrates the electric voltage U of current converter circuit arrangement 1′, which electric voltage is present at AC voltage connection AC′ and has neutral connection N′ as reference, on the basis of the switching states Sz of power semiconductor switches T1 to T6. In this case, “0” means that the power semiconductor switch in question is switched off and “1” means that the power semiconductor switch in question is switched on.

TABLE 1

| Sz | T1 | T2 | T5 | T6 | T3 | T4 | U |
|---|---|---|---|---|---|---|---|
| 0 | 1 | 0 | 1 | 0 | 1 | 0 | Udc/2 |
| 1 | 1 | 0 | 0 | 1 | 1 | 0 | 0 |
| 2 | 0 | 1 | 1 | 0 | 0 | 1 | 0 |
| 3 | 0 | 1 | 0 | 1 | 0 | 1 | −Udc/2 |

It is often desirable to use a current converter circuit arrangement to construct a multi-level current converter which can generate even more voltage levels since, as a result, it is possible to realize a particularly good approximation of the sinusoidal AC voltages generated at the AC voltage-side connections of the multi-level current converter.

FIG. 2 illustrates a further known current converter circuit arrangement 2′ which makes it possible to generate five voltage levels at AC voltage connection AC of further current converter circuit arrangement 2′ with reference to neutral connection N of further current converter circuit arrangement 2′. Further current converter circuit arrangement 2′ consists of two conventional current converter circuit arrangements 1′ which are electrically connected in parallel at their positive potential connections DC+′, negative potential connections DC−′ and neutral connections N′, wherein AC voltage connection AC′ of current converter circuit arrangement 1′ which is uppermost in FIG. 2 is electrically conductively connected to AC voltage connection AC of current converter circuit arrangement 2′ via a first inductance L1 and AC voltage connection AC′ of the current converter circuit arrangement 1′ which is lowermost in FIG. 2 is electrically conductively connected to AC voltage connection AC of further current converter circuit arrangement 2′ via a second inductance L2. Further current converter circuit arrangement 2′ generates at its AC voltage connection AC, with appropriate switching of its twelve power semiconductor switches, an electric voltage U having neutral connection N′ of the current converter circuit arrangement as its reference, the voltage value of which electric voltage may assume half the positive intermediate circuit voltage Udc/2, half the negative intermediate circuit voltage −Udc/2, a quarter of the positive intermediate circuit voltage Udc/4, a quarter of the negative intermediate circuit voltage −Udc/4 or 0 V. Thus, AC voltage connection AC of further current converter circuit arrangement 2′ can assume the five voltage levels, namely Udc/2, Udc/4, 0 V, −Udc/4 and −Udc/2, with reference to neutral connection N, that is to say the voltage U, of further current converter circuit arrangement 2′. By way of example, a three-phase multi-level current converter can be constructed from three of the above-described further current converter circuit arrangements 2′, wherein a three-phase electric load (for example, a three-phase motor) can be electrically connected to the three AC voltage connections AC of the three further current converter circuit arrangements 2′.

A disadvantage of conventional further current converter circuit arrangement 2′ is the large number of power semiconductor switches (twelve) which are required for generating the five voltage levels at the AC voltage connection of the current converter circuit arrangement.

This becomes quite expensive.

### SUMMARY OF THE INVENTION

It is an object of the invention is to provide an improved current converter arrangement wherein more voltage at the AC voltage connection of the current converter circuit arrangement may be obtained with a proportionally lower number of power semiconductor switches.

The problem addressed by the invention is to provide a current converter circuit arrangement which requires only a small number of power semiconductor switches for generating at least five voltage levels at the AC voltage connection of the current converter circuit arrangement.

The invention provides a current converter circuit arrangement having a positive potential voltage connection, a negative potential voltage connection, a neutral connection and an AC voltage connection. The inventive arrangement further includes at least six power semiconductor switches, each of which has a respective diode electrically connected back-to-back in parallel therewith, and seventh and eighth diodes. Each of the power semiconductor switches has respective first and second load current connections. The second load current connection of the first power semiconductor switch is electrically conductively connected to the first load current connection of the second power semiconductor switch, to the first load current connection of the fifth power semiconductor switch and to the cathode of the seventh diode. The second load current connection of the second power semiconductor switch is electrically conductively connected to the first load current connection of the third power semiconductor switch and to the neutral connection. The second load current connection of the third power semiconductor switch is electrically conductively connected to the first load current connection of the fourth power semiconductor switch, to the second load current connection of the sixth power semiconductor switch and to the anode of the eighth diode. The positive potential voltage connection is electrically conductively connected to the first load current connection of the first power semiconductor switch and the negative potential voltage connection is electrically conductively connected to the second load current connection of the fourth power semiconductor switch. The second load current connection of the fifth power semiconductor switch is electrically conductively connected to the cathode of the eighth diode and the first load current connection of the sixth power semiconductor switch is electrically conductively connected to the anode of the seventh diode. The second load current connection of the fifth power semiconductor switch and the cathode of the eighth diode are electrically conductively connected via a first inductance to the AC voltage connection. The first load current connection of the sixth power semiconductor switch and the anode of the seventh diode are electrically conductively connected via a second inductance to the AC voltage connection.

It proves to be advantageous if the first, second, third and fourth power semiconductor switches are each designed as IGBTs and the fifth and sixth power semiconductor switches are each designed as MOSFETs, wherein the fifth diode and the sixth diode are each integral components of the respective MOSFETs. As a result, the power loss in the current converter circuit arrangement is reduced.

A current converter device in accordance with the invention includes a current converter circuit arrangement according to the invention and a control device. The control device drives the power semiconductor switches of the current converter circuit arrangement, wherein the power semiconductor switches assume predefined switching states during operation of the current converter device. In particular switching states, the fifth power semiconductor switch is switched on while the sixth power semiconductor switch is simultaneously switched off, or the sixth power semiconductor switch is switched on while the fifth power semiconductor switch is simultaneously switched off, also proves to be advantageous. The current converter circuit arrangement is advantageously driven to achieve these conditions by the control device.

In this connection, it proves to be advantageous if the control device drives the power semiconductor switches such that the first, second, third and fourth power semiconductor switches are switched at a first switching frequency and the fifth and sixth power semiconductor switches are switched more often within a particular time period than the first, second, third or fourth power semiconductor switches. As a result of this, harmonics in the electric current flowing through the AC voltage connection are reduced.

In this connection, it proves to be further advantageous if the control device drives the fifth and sixth power semiconductor switches such that the fifth and sixth power semiconductor switches are switched at a second switching frequency which is higher than the first switching frequency. As a result of this, harmonics in the electric current flowing through the AC voltage connection are further reduced.

It also proves to be advantageous if the current converter circuit arrangement has seventh and eighth power semiconductor switches which each have first and second load current connections, wherein the seventh power semiconductor switch is electrically connected back-to-back in parallel with the seventh diode and the eighth power semiconductor switch is electrically connected back-to-back in parallel with the eighth diode. As a result, the power loss in the current converter circuit arrangement is further reduced.

In this connection, it proves to be advantageous if the first, second, third and fourth power semiconductor switches are IGBTs and the fifth, sixth, seventh and eighth power semiconductor switches are MOSFETs, wherein the fifth, sixth, seventh and eighth diodes are each integral components of the respective MOSFETs. As a result, the power loss in the current converter circuit arrangement is further reduced.

A current converter device in accordance with the instant invention may also include a current converter circuit arrangement according to the invention and a control device. The control device drives the power semiconductor switches of the current converter circuit arrangement, wherein the power semiconductor switches assume predefined switching states during operation of the current converter device. In particular switching states, it proves advantageous if the fifth and seventh power semiconductor switches are switched on while the sixth and eighth power semiconductor switches are simultaneously switched off, or the fifth and seventh power semiconductor switches are switched off while the sixth and eighth power semiconductor switches are simultaneously switched on. The current converter circuit arrangement is advantageously driven in such a way by the control device.

In this connection, it proves to be advantageous if the control device drives the power semiconductor switches such that the first, second, third and fourth power semiconductor switches are switched at a first switching frequency and the fifth, sixth, seventh and eighth power semiconductor switches are switched more often within a particular time period than the first, second, third or fourth power semiconductor switches. As a result of this, harmonics in the electric current flowing through the AC voltage connection are reduced.

In this connection, it proves to be further advantageous if the control device drives the fifth, sixth, seventh and eighth power semiconductor switches such that the fifth, sixth, seventh and eighth power semiconductor switches are switched at a second switching frequency which is higher than the first switching frequency. As a result of this, harmonics in the electric current flowing through the AC voltage connection are further reduced.

Other objects and features of the present invention will become apparent from the following detailed description of the presently preferred embodiments, considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a current converter circuit arrangement which is conventional in the art;

FIG. 2 shows a further current converter circuit arrangement which is conventional in the art;

FIG. 3 shows a current converter device having a current converter circuit arrangement according to the invention and a control device;

FIG. 4 shows signal profiles and switching states pertaining to the current converter circuit arrangement according to the invention and the control device as shown in FIG. 3;

FIG. 5 shows a further current converter device with an embodiment of a further current converter circuit arrangement according to the invention and a control device; and

FIG. 6 shows signal profiles and switching states pertaining to the embodiment of the further current converter circuit arrangement according to the invention and the control device as shown in FIG. 5.

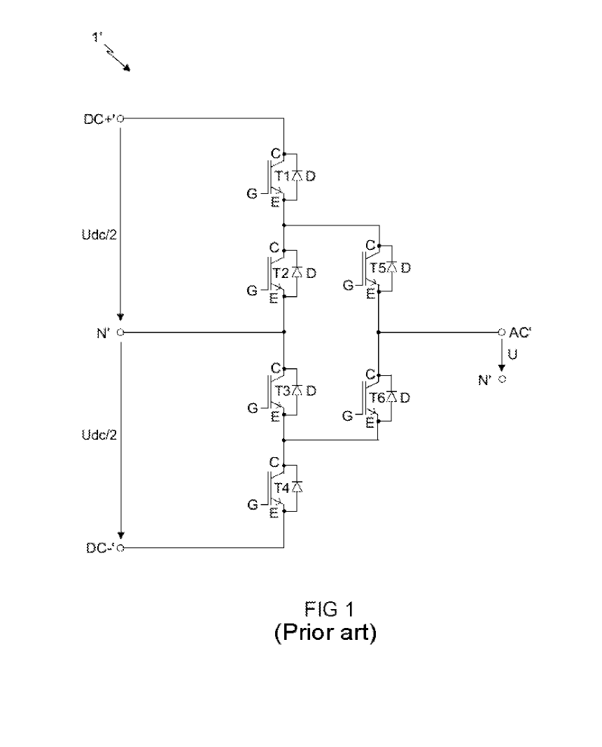

### DETAILED DESCRIPTION OF THE PRESENTLY PREFERRED EMBODIMENTS

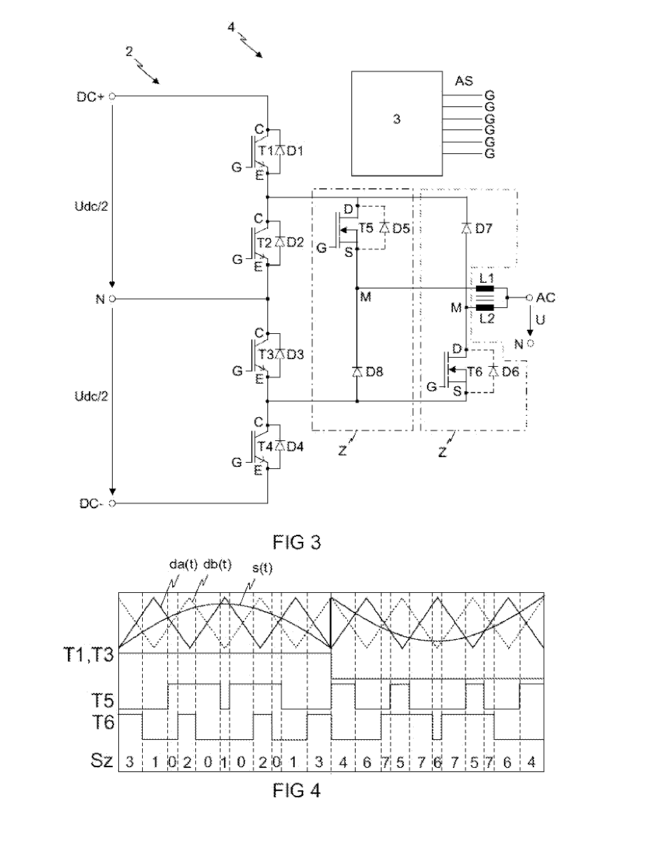

FIG. 3 illustrates a current converter device 4 which has a current converter circuit arrangement 2 according to the invention and a control device 3 which is designed to drive the power semiconductor switches of current converter circuit arrangement 2.

Current converter circuit arrangement 2 has a positive potential voltage connection DC+, a negative potential voltage connection DC−, a neutral connection N and an AC voltage connection AC.

Current converter circuit arrangement 2 also has a first power semiconductor switch T1 to which a first diode D1 is electrically connected back-to-back in parallel, a second power semiconductor switch T2 to which a second diode D2 is electrically connected back-to-back in parallel, a third power semiconductor switch T3 to which a third diode D3 is electrically connected back-to-back in parallel, a fourth power semiconductor switch T4 to which a fourth diode D4 is electrically connected back-to-back in parallel, a fifth power semiconductor switch T5 to which a fifth diode D5 is electrically connected back-to-back in parallel, and a sixth power semiconductor switch T6 to which a sixth diode D6 is electrically connected back-to-back in parallel. The power semiconductor switches each have first and second load current connections, as will be described presently.

The respective power semiconductor switches are present in general in the form of a transistor, for instance an IGBT (insulated-gate bipolar transistor) or a MOSFET (metal-oxide semiconductor field-effect transistor). Preferably, first, second, third and fourth power semiconductor switches T1 to T4 are present in the form of IGBTs, wherein first load current connections C of first, second, third and fourth power semiconductor switches T1 to T4 are present in the form of the collector of the respective IGBT and the second load current connection E of first, second, third and fourth power semiconductor switches T1 to T4 is present in the form of the emitter of the respective IGBT. Furthermore, the fifth and sixth power semiconductor switches T5 and T6 are preferably present in the form of MOSFETs, wherein first load current connection D of the fifth and sixth power semiconductor switches T5 and T6 is present in the form of the drain of the respective MOSFET and the second load current connection S of the fifth and sixth power semiconductor switches T5 and T6 is present in the form of the source of the respective MOSFET.

If the power semiconductor switch is present in the form of a MOSFET, then the diode connected back-to-back in parallel with the power semiconductor switch is generally an integral component of the MOSFET and is not present as a discrete component. A MOSFET already has a diode electrically connected back-to-back in parallel to the actual semiconductor switch owing to the semiconductor structure of the MOSFET. Within the scope of the exemplary embodiment, the fifth and sixth power semiconductor switches T5 and T6 are designed as MOSFETs, with the result that the fifth diode D5 and the sixth diode D6 are integral components of the respectively associated MOSFET, which is illustrated in FIG. 3 by indication with dashed lines.

If appropriate, for example if the electrical power of the diode connected back-to-back in parallel inherently integrated in the respective MOSFET is not sufficient, it is possible to additionally electrically connect a diode designed as a discrete component back-to-back in parallel with the respective MOSFET.

If appropriate, a plurality of power semiconductor switches can be electrically connected in parallel with one another and/or a plurality of diodes can be electrically connected in parallel in order to increase the current rating.

The power semiconductor switches have a control connection G which is present in the form of the gate of the respective power semiconductor switch within the scope of the exemplary embodiment. It is possible to control the switching-on and switching-off of the power semiconductor switches via the control connections G of the power semiconductor switches. Control device 3 is electrically conductively connected to the control connections G of the power semiconductor switches and generates drive signals AS for driving the power semiconductor switches of current converter circuit arrangement 2. For the sake of clarity, the electrical connections from control device 3 to the control connections G of the power semiconductor switches are not illustrated in FIG. 3.

Furthermore, current converter circuit arrangement 2 has seventh and eighth diodes D7 and D8. It should be noted that seventh and eighth diodes D7 and D8 may also be integral components of a MOSFET.

The second load current connection E of first power semiconductor switch T1 is electrically conductively connected to first load current connection C of second power semiconductor switch T2, to first load current connection D of fifth power semiconductor switch T5 and to the cathode of seventh diode D7. Furthermore, second load current connection E of second power semiconductor switch T2 is electrically conductively connected to first load current connection C of third power semiconductor switch T3 and to neutral connection N. Furthermore, second load current connection E of third power semiconductor switch T3 is electrically conductively connected to first load current connection C of fourth power semiconductor switch T4, to second load current connection S of sixth power semiconductor switch T6 and to the anode of eighth diode D8.

Furthermore, positive potential voltage connection DC+ is electrically conductively connected to first load current connection C of first power semiconductor switch T1 and negative potential voltage connection DC− is electrically conductively connected to second load current connection E of fourth power semiconductor switch T4. Second load current connection S of fifth power semiconductor switch T5 is electrically conductively connected to the cathode of eighth diode D8 and first load current connection D of sixth power semiconductor switch T6 is electrically conductively connected to the anode of seventh diode D7.

Furthermore, second load current connection S of fifth power semiconductor switch T5 and the cathode of eighth diode D8 are electrically conductively connected via a first inductance L1 to AC voltage connection AC. First inductance L1 is electrically connected between second load current connection S of fifth power semiconductor switch T5 and AC voltage connection AC, and electrically connected between the cathode of eighth diode D8 and AC voltage connection AC.

Furthermore, first load current connection D of sixth power semiconductor switch T6 and the anode of seventh diode D7 are electrically conductively connected via a second inductance L2 to AC voltage connection AC. Second inductance L2 is electrically connected between first load current connection D of sixth power semiconductor switch T6 and AC voltage connection AC, and electrically connected between the anode of seventh diode D7 and AC voltage connection AC.

In each case half the intermediate circuit voltage Udc/2 is present between positive potential connection DC+ and neutral connection N and between negative potential connection DC− and neutral connection N. For this purpose, current converter circuit arrangement 2 is fed from two voltage sources—not illustrated in FIG. 3—which each generate half the intermediate circuit voltage Udc/2.

The following switching-state table (TABLE 2) illustrates the electric voltage U of current converter circuit arrangement 2, which electric voltage is present at AC voltage connection AC and has neutral connection N as reference, on the basis of the switching states Sz of the power semiconductor switches T1 to T6. In this case, “0” means that the power semiconductor switch in question is switched off and “1” means that the power semiconductor switch in question is switched on.

TABLE 2

| Sz | T1 | T2 | T5 | T6 | T3 | T4 | U |
|---|---|---|---|---|---|---|---|
| 0 | 1 | 0 | 1 | 0 | 1 | 0 | Udc/2 |
| 1 | 1 | 0 | 0 | 0 | 1 | 0 | Udc/4 |
| 2 | 1 | 0 | 1 | 1 | 1 | 0 | Udc/4 |
| 3 | 1 | 0 | 0 | 1 | 1 | 0 | 0 |
| 4 | 0 | 1 | 1 | 0 | 0 | 1 | 0 |
| 5 | 0 | 1 | 1 | 1 | 0 | 1 | −Udc/4 |
| 6 | 0 | 1 | 0 | 0 | 0 | 1 | −Udc/4 |
| 7 | 0 | 1 | 0 | 1 | 0 | 1 | −Udc/2 |

Current converter circuit arrangement 2 according to the invention generates at its AC voltage connection AC with appropriate switching of its power semiconductor switches T1 to T6 an electric voltage U having neutral connection N of the current converter circuit arrangement as its reference, the voltage value of which electric voltage may assume half the positive intermediate circuit voltage Udc/2, half the negative intermediate circuit voltage −Udc/2, a quarter of the positive intermediate circuit voltage Udc/4, a quarter of the negative intermediate circuit voltage −Udc/4 or 0 V. Thus, AC voltage connection AC of current converter circuit arrangement 2 according to the invention can assume the five voltage levels, namely Udc/2, Udc/4, 0 V, −Udc/4 and −Udc/2, with reference to neutral connection N, that is to say the voltage U.

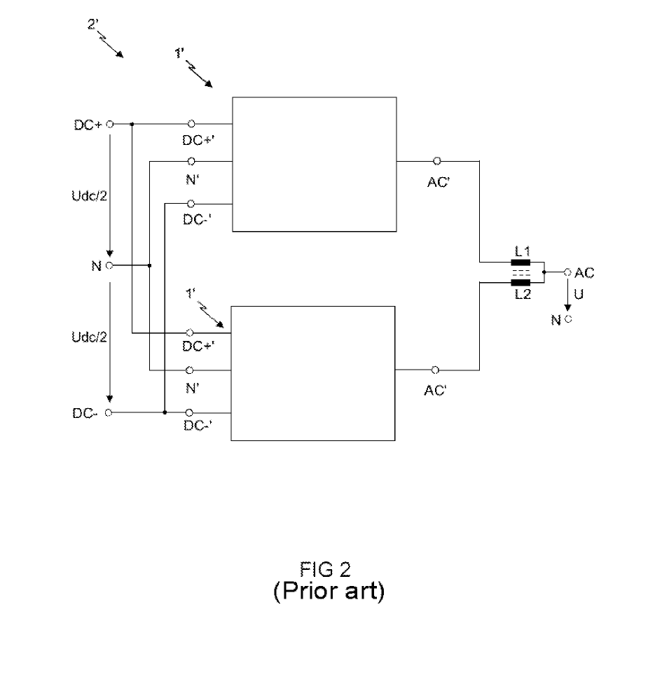

Thus, current converter circuit arrangement 2 according to the invention requires only six power semiconductor switches to generate the five voltage levels Udc/2, Udc/4, 0 V, −Udc/4 and −Udc/2, while current converter circuit arrangement 2′ which is conventional in the art illustrated in FIG. 2 requires 12 power semiconductor switches to generate the five voltage levels Udc/2, Udc/4, 0 V, −Udc/4 and −Udc/2.

FIG. 4 illustrates the signal profiles and switching states pertaining to current converter circuit arrangement 2 according to the invention shown in FIG. 3 which are produced when the power semiconductor switches of current converter circuit arrangement 2 are advantageously driven by control device 3. Control device 3 is electrically conductively connected to control connections G of the power semiconductor switches and generates drive signals AS for driving the power semiconductor switches of current converter circuit arrangement 2. Control device 3 switches on (forward-biased state, current flows through the power semiconductor switches from the first to the second load current connection of the power semiconductor switch) and switches off (reverse-biased state, no current flows through the power semiconductor switches from the first to the second load current connection of the power semiconductor switch) the power semiconductor switches of current converter circuit arrangement 2 by means of the drive signals AS.

A reference signal vref(t) is preferably generated internally by control device 3 according to

vref(t)=m·sin(2·π·f₁·t) FORMULA 1

with time t, a first frequency f1 and a modulation factor m which is given by

$$m = \frac{\sqrt{2} \cdot Ueff}{\frac{Udc}{2}} \qquad FORMULA 2$$

wherein Ueff is the rms value of the voltage U.

First and third power semiconductor switches T1 and T3 are switched on if reference signal vref(t) is positive and switched off if reference signal vref(t) is negative. Second and fourth power semiconductor switches T2 and T4 are switched inversely with respect to first and third power semiconductor switches T1 and T3, that is to say second and fourth power semiconductor switches T2 and T4 are switched on if reference signal vref(t) is negative and switched off if reference signal vref(t) is positive. First, second, third and fourth power semiconductor switches T1, T2, T3, and T4 are consequently switched at a first switching frequency f1 which corresponds to first frequency f1 of reference signal vref(t).

Furthermore, a control signal s(t) is preferably generated internally by control device 3 according to

s(t)=2·vref(t)−2·a(T1)+1 FORMULA 3

wherein a(T1)=1 if T1 is switched on and a(T1)=0 if T1 is switched off.

Furthermore, first and second triangular signals da(t) and db(t) are preferably generated internally by control device 3, which triangular signals have a frequency which is preferably substantially higher than first frequency f1. Second triangular signal db(t) is phase-shifted by 180° with respect to first triangular signal da(t).

The switching instants of fifth power semiconductor switch T5 arise from a comparison of control signal s(t) with first triangular signal da(t). Fifth power semiconductor switch T5 is switched on if first triangular signal da(t) is smaller than control signal s(t). Fifth power semiconductor switch T5 is switched off if first triangular signal da(t) is greater than or equal to control signal s(t).

The switching instants of sixth power semiconductor switch T6 arise from a comparison of control signal s(t) with second triangular signal db(t). Sixth power semiconductor switch T6 is switched on if second triangular signal db(t) is greater than control signal s(t). Sixth power semiconductor switch T6 is switched off if second triangular signal db(t) is smaller than or equal to control signal s(t).

What results is the sequence of switching states Sz of the power semiconductor switches illustrated in FIG. 4.

As can be seen in the above switching-state table (TABLE 2) and in FIG. 4, in certain switching states Sz, fifth power semiconductor switch T5 is switched on while sixth power semiconductor switch T6 is simultaneously switched off or sixth power semiconductor switch T6 is switched on while fifth power semiconductor switch T5 is simultaneously switched off.

Preferably, first, second, third, fourth, fifth and sixth power semiconductor switches T1, T2, T3, T4, T5 and T6 are driven by control device 3 such that first, second, third and fourth power semiconductor switches T1, T2, T3 and T4 are switched at a first switching frequency f1 and the fifth and sixth power semiconductor switches T5 and T6 are switched (switched on and off) more often within a particular time period, for example over one period of first switching frequency f1, than first, second, third or fourth power semiconductor switches T1, T2, T3 or T4. Since an IGBT has lower forward losses but higher switching losses compared to a MOSFET, it is therefore advantageous if first, second, third and fourth power semiconductor switches T1, T2, T3 and T4 are each designed as IGBTs and fifth and sixth power semiconductor switches T5 and T6 are each designed as MOSFETs, wherein fifth diode D5 and sixth diode D6 are each integral components of the respective MOSFETs, in order to minimize the power losses of current converter circuit arrangement 2.

Preferably, first and second triangular signal da(t) and db(t) have a significantly higher frequency than illustrated in FIG. 4. Thus, very many switch-on and switch-off processes of fifth and sixth power semiconductor switches T5 and T6 occur over one period of first switching frequency f1, with the result that the interval between two successive respective switch-on processes of fifth and sixth power semiconductor switches T5 and T6 is practically constant. Fifth and sixth power semiconductor switches T5 and T6 are therefore preferably switched at a second switching frequency f2 which is higher than first switching frequency f1 at which first, second, third and fourth power semiconductor switches T1, T2, T3 and T4 are switched. Fifth and sixth power semiconductor switches T5 and T6 are therefore preferably driven by control device 3 such that fifth and sixth power semiconductor switches T5 and T6 are switched at a second switching frequency f2 which is higher than first switching frequency f1. First switching frequency f1 is preferably 50 Hz or 60 Hz, whereas second switching frequency f2 is preferably 5 kHz to 60 kHz.

Within the scope of the exemplary embodiment, current converter circuit arrangement 2 has two half-bridge branches Z which are electrically connected in parallel and which are designed in each case as an electrical series circuit composed of a power semiconductor switch T5 or T6 (with diode D5 or D6 electrically connected back-to-back in parallel) and a diode D7 or D8. The two half-bridge branches Z each have a center-point connection M via which they are connected via a respective inductance L1 or L2 to AC voltage connection AC. If current converter circuit arrangement 2 is intended to be able to generate even more than five voltage levels, current converter circuit arrangement 2 can be extended by any number of identically constructed—like the two half-bridge branches Z illustrated in FIG. 3—additional half-bridge branches Z which are electrically connected in parallel with the two half-bridge branches Z which exist within the scope of the exemplary embodiment, wherein the respective center-point connection M of the respective additional half-bridge branches Z is connected to AC voltage connection AC via a respective inductance, in an identical manner to the existing two half-bridge branches Z. All inductances are preferably magnetically coupled to one another.

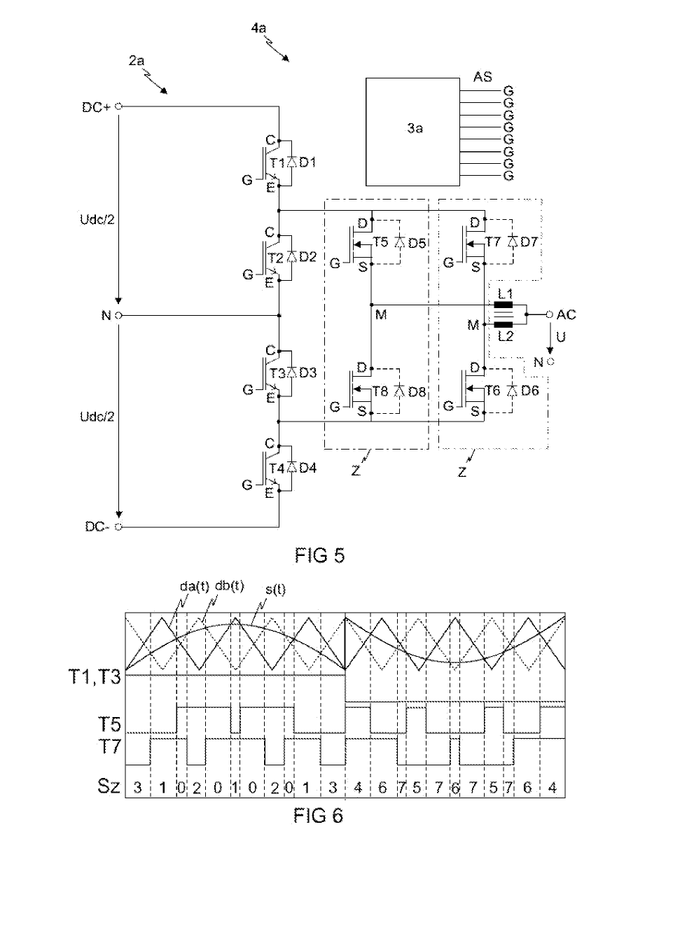

FIG. 5 illustrates a further current converter device 4a which has an embodiment of a further current converter circuit arrangement 2a according to the invention and a control device 3a which is designed to control the power semiconductor switches of current converter circuit arrangement 2a. Current converter circuit arrangement 2a according to the invention corresponds to current converter circuit arrangement 2 according to the invention apart from the feature that current converter circuit arrangement 2a has seventh and eighth power semiconductor switches T7 and T8 which each have first and a second load current connections D and S, wherein seventh power semiconductor switch T7 is electrically connected back-to-back in parallel with seventh diode D7 and eighth power semiconductor switch T8 is electrically connected back-to-back in parallel with eighth diode D8. Second load current connection S of seventh power semiconductor switch T7 is thus electrically conductively connected to first load current connection D of eighth power semiconductor switch T8 and second load current connection S of fifth power semiconductor switch T5 is thus electrically conductively connected to first load current connection D of eighth power semiconductor switch T8.

First, second, third and fourth power semiconductor switches T1, T2, T3 and T4 are preferably each designed as IGBTs and fifth, sixth, seventh and eighth power semiconductor switches T5, T6, T7 and T8 are each preferably designed as MOSFETs, wherein fifth, sixth, seventh and eighth diodes D5, D6, D7 and D8 are each integral components of the respectively associated MOSFETs, which is illustrated in FIG. 5 by indication with dashed lines.

If appropriate, for example if the electrical power of the diode connected back-to-back in parallel inherently integrated in the respective MOSFET is not sufficient, it is possible to additionally electrically connect a diode designed as a discrete component back-to-back in parallel with the respective MOSFET.

If appropriate, a plurality of power semiconductor switches can be electrically connected in parallel with one another and/or a plurality of diodes can be electrically connected in parallel with one another in order to increase the current rating.

In comparison with control device 3, control device 3a is additionally electrically conductively connected to control connections G of seventh and eighth power semiconductor switches T7 and T8 and generates drive signals AS for driving the power semiconductor switches of current converter circuit arrangement 2a.

The following switching-state table illustrates the electric voltage U of current converter circuit arrangement 2a, which electric voltage is present at AC voltage connection AC and has neutral connection N as reference, on the basis of the switching states Sz of power semiconductor switches T1 to T8. In this case, “0” means that the power semiconductor switch in question is switched off and “1” means that the power semiconductor switch in question is switched on.

TABLE 3

| Sz | T1 | T2 | T5 | T8 | T7 | T6 | T3 | T4 | U |
|---|---|---|---|---|---|---|---|---|---|
| 0 | 1 | 0 | 1 | 0 | 1 | 0 | 1 | 0 | Udc/2 |
| 1 | 1 | 0 | 0 | 1 | 1 | 0 | 1 | 0 | Udc/4 |
| 2 | 1 | 0 | 1 | 0 | 0 | 1 | 1 | 0 | Udc/4 |
| 3 | 1 | 0 | 0 | 1 | 0 | 1 | 1 | 0 | 0 |
| 4 | 0 | 1 | 1 | 0 | 1 | 0 | 0 | 1 | 0 |
| 5 | 0 | 1 | 1 | 0 | 0 | 1 | 0 | 1 | −Udc/4 |
| 6 | 0 | 1 | 0 | 1 | 1 | 0 | 0 | 1 | −Udc/4 |
| 7 | 0 | 1 | 0 | 1 | 0 | 1 | 0 | 1 | −Udc/2 |

Current converter circuit arrangement 2a according to the invention generates, at its AC voltage connection AC with appropriate switching of its power semiconductor switches T1 to T8, an electric voltage U having neutral connection N of the current converter circuit arrangement as its reference, the voltage value of which electric voltage may assume half the positive intermediate circuit voltage Udc/2, half the negative intermediate circuit voltage −Udc/2, a quarter of the positive intermediate circuit voltage Udc/4, a quarter of the negative intermediate circuit voltage −Udc/4 or 0 V. Thus, AC voltage connection AC of current converter circuit arrangement 2a according to the invention can assume five voltage levels, namely Udc/2, Udc/4, 0 V, −Udc/4 and −Udc/2, with reference to neutral connection N, that is to say the voltage U.

Current converter circuit arrangement 2a according to the invention requires two power semiconductor switches more compared to current converter circuit arrangement 2 according to the invention for generating the five voltage levels Udc/2, Udc/4, 0 V, −Udc/4 and −Udc/2, but still four fewer power semiconductor switches than conventional current converter circuit arrangement 2′ illustrated in FIG. 2. Current converter circuit arrangement 2a according to the invention has the advantage over current converter circuit arrangement 2 that current converter circuit arrangement 2a has lower power losses and thus a higher degree of efficiency than current converter circuit arrangement 2.

FIG. 6, in an analogous manner to FIG. 4, illustrates signal profiles and switching states pertaining to current converter circuit arrangement 2a according to the invention as shown in FIG. 5, which signal profiles and switching states occur in the event of advantageous driving of the power semiconductor switches of current converter circuit arrangement 2a by means of control device 3a.

Control device 3a generates internally, preferably in an identical manner to above with respect to control device 3, a reference signal vref(t), a control signal s(t) and first and second triangular signals da(t) and db(t). The four signals therefore correspond to those respectively associated with the above-described signals with respect to control device 3.

First and third power semiconductor switches T1 and T3 are switched on if reference signal vref(t) is positive and switched off if reference signal vref(t) is negative. Second and fourth power semiconductor switches T2 and T4 are switched inversely with respect to first and third power semiconductor switches T1 and T3, that is to say second and fourth power semiconductor switches T2 and T4 are switched on (forward-biased state, current flows through the power semiconductor switches from the first to the second load current connection of the power semiconductor switch) if reference signal vref(t) is negative and switched off (reverse-biased state, no current flows through the power semiconductor switches from the first to the second load current connection of the power semiconductor switch) if reference signal vref(t) is positive. First, second, third and fourth power semiconductor switches T1, T2, T3, and T4 are consequently switched at a first switching frequency f1 which corresponds to first frequency f1 of reference signal vref(t).

The switching instants of fifth power semiconductor switch T5 arise from a comparison of control signal s(t) with first triangular signal da(t). Fifth power semiconductor switch T5 is switched on if first triangular signal da(t) is smaller than control signal s(t). Fifth power semiconductor switch T5 is switched off if first triangular signal da(t) is greater than or equal to control signal s(t).

The switching instants of seventh power semiconductor switch T7 arise from a comparison of control signal s(t) with second triangular signal db(t). Seventh power semiconductor switch T7 is switched on if second triangular signal db(t) is smaller than control signal s(t). Seventh power semiconductor switch T7 is switched off if second triangular signal db(t) is greater than or equal to control signal s(t).

Eighth power semiconductor switch T8 is switched inversely with respect to fifth power semiconductor switch T5, that is to say eighth power semiconductor switch T8 is switched on when fifth power semiconductor switch T5 is switched off and is switched off when fifth power semiconductor switch T5 is switched on.

Sixth power semiconductor switch T6 is switched inversely with respect to seventh power semiconductor switch T7, that is to say sixth power semiconductor switch T6 is switched on when seventh power semiconductor switch T7 is switched off and is switched off when seventh power semiconductor switch T7 is switched on.

What results is the sequence of switching states Sz of the power semiconductor switches illustrated in FIG. 6.

As can be seen in the above switching-state table (TABLE 2) and in FIG. 6, in certain switching states Sz, fifth and seventh power semiconductor switches T5 and T7 are switched on while sixth and eighth power semiconductor switches T6 and T8 are simultaneously switched off or fifth and seventh power semiconductor switches T5 and T7 are switched off while sixth and eighth power semiconductor switches T6 and T8 are simultaneously switched on.

Preferably, first, second, third, fourth, fifth, sixth, seventh and eighth power semiconductor switches T1, T2, T3, T4, T5, T6, T7 and T8 are driven by control device 3a such that first, second, third and fourth power semiconductor switches T1, T2, T3 and T4 are switched at a first switching frequency f1 and fifth, sixth, seventh and eighth power semiconductor switches T5, T6, T7 and T8 are switched (switched on and off) more often within a particular time period, for example over one period of first switching frequency f1, than first, second, third or fourth power semiconductor switches T1, T2, T3 and T4. Since an IGBT has lower forward losses but higher switching losses compared to a MOSFET, it is therefore advantageous if first, second, third and fourth power semiconductor switches T1, T2, T3 and T4 are each designed as IGBTs and fifth, sixth, seventh and eighth power semiconductor switches T5, T6, T7 and T8 are each designed as MOSFETs, wherein fifth diode D5, sixth diode D6, seventh diode D7 and eighth diode D8 are each integral components of the respective MOSFETs, in order to minimize the power losses of current converter circuit arrangement 2a.

Preferably, first and second triangular signal da(t) and db(t) have a significantly higher frequency than illustrated in FIG. 6. Thus, very many switch-on and switch-off processes of fifth, sixth, seventh and eighth power semiconductor switches T5, T6, T7 and T8 occur over one period of first switching frequency f1, with the result that the interval between two successive respective switch-on processes of fifth, sixth, seventh and eighth power semiconductor switches T5, T6, T7 and T8 is practically constant. Fifth, sixth, seventh and eighth power semiconductor switches T5, T6, T7 and T8 are therefore preferably switched at a second switching frequency f2 which is higher than first switching frequency f1 at which first, second, third and fourth power semiconductor switches T1, T2, T3 and T4 are switched. Fifth, sixth, seventh and eighth power semiconductor switches T5, T6, T7 and T8 are therefore preferably driven by control device 3a such that fifth, sixth, seventh and eighth power semiconductor switches T5, T6, T7 and T8 are switched at a second switching frequency f2 which is higher than first switching frequency f1.

First switching frequency f1 is preferably 50 Hz or 60 Hz, whereas second switching frequency f2 is preferably 5 kHz to 60 kHz.

Within the scope of the exemplary embodiment, current converter circuit arrangement 2a has two half-bridge branches Z which are electrically connected in parallel and which are designed in each case as an electrical series circuit composed of a power semiconductor switch T5 or T7 (with diode D5 or D7 electrically connected back-to-back in parallel) and a power semiconductor switch T8 or T6 (with diode D8 or D6 electrically connected back-to-back in parallel). The two half-bridge branches Z each have a center-point connection M via which they are connected via a respective inductance L1 or L2 to AC voltage connection AC. If current converter circuit arrangement 2a is intended to be able to generate more than five voltage levels, current converter circuit arrangement 2a can be extended by any number of identically constructed—like the two half-bridge branches Z illustrated in FIG. 5—additional half-bridge branches Z which are electrically connected in parallel with the two half-bridge branches Zb which exist within the scope of the exemplary embodiment, wherein each respective center-point connection M of the respective additional half-bridge branches Z is connected to AC voltage connection AC via a respective inductance, in an identical manner to the existing two half-bridge branches Z. All inductances are preferably magnetically coupled to one another.

In general, current converter circuit arrangement 2a can generate 2·N+1 voltage levels, wherein N is the number of half-bridge branches Z. In the exemplary embodiment shown in FIG. 5, N=2, and so five voltage levels result. If, for example, an additional half-bridge branch Z were added, N=3, and so seven voltage levels result at AC voltage connection AC, etc.

It should be noted that a respective IGBT can optionally be electrically connected in parallel with the MOSFETs arranged in half-bridge branches Z. If the respective MOSFET switches on, the IGBT electrically connected in parallel therewith then switches on, with the result that some of the current flowing through the respective MOSFET commutates to the IGBT connected in parallel therewith. When the IGBT is switched on, there is only a very low voltage across the IGBT, with the result that only a very low power loss occurs in the IGBT when the IGBT is switched. Since an IGBT has lower forward losses compared with a MOSFET, the power loss in current converter circuit arrangement 2 or 2a is reduced as a result.

First and second inductances L1 and L2, and optionally further inductances present which are electrically connected between AC voltage connection AC and the center-point connection M of the respective half-bridge branch Z, are preferably present in the form of a winding wound on a magnetizable core (coil with core). It should be noted that the inductances are preferably magnetically coupled to one another (indicated in FIG. 3 and FIG. 5 by two lines between the inductances), that is to say the windings of the inductances are wound on a common magnetizable core. As a result of this, the inductances can be designed in a particularly structurally compact manner.

It should also be noted that neutral connection N of current converter circuit arrangement 2 or 2a may be electrically conductively connected to ground.

It should also be noted that current converter circuit arrangement 2 or 2a according to the invention can be electrically interconnected with a further current converter circuit arrangement 2 or 2a according to the invention to form a converter device, by the positive potential voltage connections (DC+) of the two current converter circuit arrangements being electrically conductively connected to one another and the negative potential voltage connections (DC−) of the two current converter circuit arrangements being electrically conductively connected to one another. The number of half-bridge branches Z of current converter circuit arrangement 2 or 2a according to the invention and of the further current converter circuit arrangement 2 or 2a according to the invention may be different. The converter device can be used, for example, to convert an AC voltage present at AC voltage connection AC of current converter circuit arrangement 2 or 2a according to the invention, which AC voltage has a particular frequency, into an AC voltage present at AC voltage connection AC of the further current converter circuit arrangement 2 or 2a according to the invention, which AC voltage has another frequency. The neutral connections N of the two current converter circuit arrangements can be electrically connected to one another in this case. Furthermore, the neutral connections N of the two current converter circuit arrangements can be electrically connected to ground.

It should be noted that the respective MOSFETs may be present, for example, as Si MOSFETs or SiC (silicon carbide) MOSFETs.

It should be noted that the respective diodes may be present, for example, as Si diodes or SiC (silicon carbide) diodes.

It should also be noted that features of different exemplary embodiments of the invention can of course be combined with one another in any way, provided that the features are not mutually exclusive.

In the preceding Detailed Description, reference was made to the accompanying drawings, which form a part of this disclosure, and in which are shown illustrative specific embodiments of the invention. In this regard, directional terminology, such as “top”, “bottom”, “left”, “right”, “front”, “back”, etc., is used with reference to the orientation of the Figure(s) with which such terms are used. Because components of embodiments can be positioned in a number of different orientations, the directional terminology is used for purposes of ease of understanding and illustration only and is not to be considered limiting.

Additionally, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A current converter circuit arrangement comprising:
a positive potential voltage connection;
a negative potential voltage connection;
a neutral connection;
an AC voltage connection;
a first power semiconductor switch having first and second load current connections;
a first diode which is electrically connected back-to-back in parallel with said first power semiconductor switch;
a second power semiconductor switch having first and second load current connections;
a second diode which is electrically connected back-to-back in parallel with said second power semiconductor switch;
a third power semiconductor switch having first and second load current connections;
a third diode which is electrically connected back-to-back in parallel with said third power semiconductor switch;
a fourth power semiconductor switch having first and second load current connections;
a fourth diode which is electrically connected back-to-back in parallel with said fourth power semiconductor switch;
a fifth power semiconductor switch having first and second load current connections;
a fifth diode which is electrically connected back-to-back in parallel with said fifth power semiconductor switch;
a sixth power semiconductor switch having first and second load current connections;
a sixth diode which is electrically connected back-to-back in parallel with said sixth power semiconductor switch;
seventh and eighth diodes;
a first inductance which electrically conductively connects said AC voltage connection to said second load current connection of said fifth power semiconductor switch and the cathode of said eighth diode; and
a second inductance which electrically conductively connects said AC voltage connection to said first load current connection of said sixth power semiconductor switch and the anode of said seventh diode;
wherein said second load current connection of said first power semiconductor switch is electrically conductively connected to said first load current connection of said second power semiconductor switch, to said first load current connection of said fifth power semiconductor switch and to the cathode of said seventh diode;
wherein said second load current connection of said second power semiconductor switch is electrically conductively connected to said first load current connection of said third power semiconductor switch and to said neutral connection;
wherein said second load current connection of said third power semiconductor switch is electrically conductively connected to said first load current connection of said fourth power semiconductor switch, to said second load current connection of said sixth power semiconductor switch and to the anode of said eighth diode;
wherein said positive potential voltage connection is electrically conductively connected to said first load current connection of said first power semiconductor switch;
wherein said negative potential voltage connection is electrically conductively connected to said second load current connection of said fourth power semiconductor switch;
wherein said second load current connection of said fifth power semiconductor switch is electrically conductively connected to the cathode of said eighth diode; and
wherein said first load current connection of said sixth power semiconductor switch is electrically conductively connected to the anode of said seventh diode.

2. The current converter circuit arrangement of claim 1, wherein said first, second, third and fourth power semiconductor switches are each IGBTs and said fifth and sixth power semiconductor switches are each MOSFETs; and
wherein said fifth diode and said sixth diode are each integral components of the respective MOSFETs.

3. The current converter circuit arrangement of claim 1, further comprising:
a seventh power semiconductor switch having first and second load current connections; and
an eighth power semiconductor switch having first and second load current connections;
wherein said seventh power semiconductor switch is electrically connected back-to-back in parallel with said seventh diode and said eighth power semiconductor switch is electrically connected back-to-back in parallel with said eighth diode.

4. The current converter circuit arrangement of claim 3,
wherein said first, second, third and fourth power semiconductor switches are each IGBTs and said fifth, sixth, seventh and eighth power semiconductor switches are each MOSFETs; and
wherein said fifth, sixth, seventh and eighth diodes are each integral components of the respective MOSFET.

5. A current converter device comprising:
a current converter circuit arrangement which includes
a positive potential voltage connection;
a negative potential voltage connection;
a neutral connection;
an AC voltage connection;
a first power semiconductor switch having first and second load current connections;
a first diode which is electrically connected back-to-back in parallel with said first power semiconductor switch;
a second power semiconductor switch having first and second load current connections;
a second diode which is electrically connected back-to-back in parallel with said second power semiconductor switch;
a third power semiconductor switch having first and second load current connections;
a third diode which is electrically connected back-to-back in parallel with said third power semiconductor switch;
a fourth power semiconductor switch having first and second load current connections;
a fourth diode which is electrically connected back-to-back in parallel with said fourth power semiconductor switch;
a fifth power semiconductor switch having first and second load current connections;
a fifth diode which is electrically connected back-to-back in parallel with said fifth power semiconductor switch;
a sixth power semiconductor switch having first and second load current connections;
a sixth diode which is electrically connected back-to-back in parallel with said sixth power semiconductor switch;
seventh and eighth diodes;
a first inductance which electrically conductively connects said AC voltage connection to said second load current connection of said fifth power semiconductor switch and the cathode of said eighth diode; and
a second inductance which electrically conductively connects said AC voltage connection to said first load current connection of said sixth power semiconductor switch and the anode of said seventh diode;
wherein said second load current connection of said first power semiconductor switch is electrically conductively connected to said first load current connection of said second power semiconductor switch, to said first load current connection of said fifth power semiconductor switch and to the cathode of said seventh diode;
wherein said second load current connection of said second power semiconductor switch is electrically conductively connected to said first load current connection of said third power semiconductor switch and to said neutral connection;
wherein said second load current connection of said third power semiconductor switch is electrically conductively connected to said first load current connection of said fourth power semiconductor switch, to said second load current connection of said sixth power semiconductor switch and to the anode of said eighth diode;
wherein said positive potential voltage connection is electrically conductively connected to said first load current connection of said first power semiconductor switch;
wherein said negative potential voltage connection is electrically conductively connected to said second load current connection of said fourth power semiconductor switch;
wherein said second load current connection of said fifth power semiconductor switch is electrically conductively connected to the cathode of said eighth diode; and
wherein said first load current connection of said sixth power semiconductor switch is electrically conductively connected to the anode of said seventh diode; and
a control device for driving said first, second, third, fourth, fifth and sixth power semiconductor switches;
wherein said first, second, third, fourth, fifth and sixth power semiconductor switches each assume predefined switching states during operation of the current converter device, namely, in particular switching states, at least one of the following switching states exists: said fifth power semiconductor switch is switched on while said sixth power semiconductor switch is simultaneously switched off, and said sixth power semiconductor switch is switched on while said fifth power semiconductor switch is simultaneously switched off.

6. The current converter device of claim 5,
wherein said first, second, third and fourth power semiconductor switches are each IGBTs and said fifth and sixth power semiconductor switches are each MOSFETs; and
wherein said fifth diode and said sixth diode are each integral components of the respective MOSFETs.

7. The current converter device of claim 5, wherein said control device drives said first, second, third, fourth, fifth and sixth power semiconductor switches such that said first, second, third and fourth power semiconductor switches are switched at a first switching frequency and said fifth and sixth power semiconductor switches are switched so that said fifth and sixth power semiconductor switches are switched more often during a particular time period than are said first, second, third and fourth power semiconductor switches.

8. The current converter device of claim 7, wherein said control device drives said fifth and sixth power semiconductor switches such that said fifth and sixth power semiconductor switches are switched at a second switching frequency which is higher than said first switching frequency.

9. A current converter device comprising:
a current converter circuit arrangement which includes
a positive potential voltage connection;
a negative potential voltage connection;
a neutral connection;
an AC voltage connection;
a first power semiconductor switch having first and second load current connections;
a first diode which is electrically connected back-to-back in parallel with said first power semiconductor switch;
a second power semiconductor switch having first and second load current connections;
a second diode which is electrically connected back-to-back in parallel with said second power semiconductor switch;
a third power semiconductor switch having first and second load current connections;
a third diode which is electrically connected back-to-back in parallel with said third power semiconductor switch;
a fourth power semiconductor switch having first and second load current connections;
a fourth diode which is electrically connected back-to-back in parallel with said fourth power semiconductor switch;
a fifth power semiconductor switch having first and second load current connections;
a fifth diode which is electrically connected back-to-back in parallel with said fifth power semiconductor switch;
a sixth power semiconductor switch having first and second load current connections;
a sixth diode which is electrically connected back-to-back in parallel with said sixth power semiconductor switch;
a seventh power semiconductor switch having first and second load current connections;
a seventh diode which is electrically connected back-to-back in parallel with said seventh power semiconductor switch;
an eighth power semiconductor switch having first and second load current connections; and
an eighth diode which is electrically connected back-to-back in parallel with said eighth power semiconductor switch;
a first inductance which electrically conductively connects said AC voltage connection to said second load current connection of said fifth power semiconductor switch and the cathode of said eighth diode; and
a second inductance which electrically conductively connects said AC voltage connection to said first load current connection of said sixth power semiconductor switch and the anode of said seventh diode;
wherein said second load current connection of said first power semiconductor switch is electrically conductively connected to said first load current connection of said second power semiconductor switch, to said first load current connection of said fifth power semiconductor switch and to the cathode of said seventh diode;
wherein said second load current connection of said second power semiconductor switch is electrically conductively connected to said first load current connection of said third power semiconductor switch and to said neutral connection;
wherein said second load current connection of said third power semiconductor switch is electrically conductively connected to said first load current connection of said fourth power semiconductor switch, to said second load current connection of said sixth power semiconductor switch and to the anode of said eighth diode;
wherein said positive potential voltage connection is electrically conductively connected to said first load current connection of said first power semiconductor switch;
wherein said negative potential voltage connection is electrically conductively connected to said second load current connection of said fourth power semiconductor switch;
wherein said second load current connection of said fifth power semiconductor switch is electrically conductively connected to the cathode of said eighth diode; and
wherein said first load current connection of said sixth power semiconductor switch is electrically conductively connected to the anode of said seventh diode; and
a control device for driving said first, second, third, fourth, fifth, sixth, seventh and eighth power semiconductor switches;
wherein said first, second, third, fourth, fifth, sixth, seventh and eighth power semiconductor switches assume predefined switching states during operation of the current converter device, namely, in particular switching states, at least one of the following switching states exists: said fifth and seventh power semiconductor switches are switched on while said sixth and eighth power semiconductor switches are simultaneously switched off, and said fifth and seventh power semiconductor switches are switched off while said sixth and eighth power semiconductor switches are simultaneously switched on.

10. The current converter circuit arrangement of claim 9,
wherein said first, second, third and fourth power semiconductor switches are each IGBTs and said fifth, sixth, seventh and eighth power semiconductor switches are each MOSFETs; and
wherein said fifth, sixth, seventh and eighth diodes are each integral components of the respective MOSFET.

11. The current converter device as claimed in claim 9, wherein said control device drives said first, second, third, fourth, fifth, sixth, seventh and eighth power semiconductor switches such that said first, second, third and fourth power semiconductor switches are switched at a first switching frequency and said fifth, sixth, seventh and eighth power semiconductor switches are switched so that said fifth and sixth power semiconductor switches are switched more often during a particular time period than are said first, second, third and fourth power semiconductor switches.

12. The current converter device as claimed in claim 10, wherein said control device drives said fifth, sixth, seventh and eighth power semiconductor switches such that said fifth, sixth, seventh and eighth power semiconductor switches are switched at a second switching frequency which is higher than said first switching frequency.
